(19) United States
(12) Patent Application Publication
(10) Pub. No.: US 2007/0170679 A1
(43) Pub. Date: Jul. 26, 2007

(54) Valve device for a pneumatic suspension unit of a vehicle

(76) Inventors: Axel Stender, Hamela (DE); Rainer Risse, Pattensen (DE); Johann Lucas, Sehnde (DE); Norbert Witte, Lauenau (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/579,127

(22) PCT Filed: Oct. 9, 2004
(86) PCT No.: PCT/EP04/11322

§ 371 Date: May 12, 2006

(30) Foreign Application Priority Data
Nov. 19, 2003 (DE) 103 54 056.3

(51) Int. Cl. B60G 11/26; F16F 9/04; F16K 11/16

(52) U.S. Cl. 280/124.16; 267/64.21; 137/636.1

(57) ABSTRACT

The invention relates to a valve device (1) for an air-suspension device for a vehicle, containing a manually actuatable air-admission valve (10, 34, 46) for admission of air to the air-suspension bellows (3) of the air-suspension device, a manually actuatable vent valve (11, 35, 47) for venting the air-suspension bellows (3) and a first electrically actuatable valve (7, 32, 44), the air-admission valve (10, 34, 46), the vent valve (11, 35, 47) and the first electrically actuatable valve (7, 32, 44) being disposed in a common housing (55). On this basis there is specified, for an air-suspension device for a vehicle, a valve device that can be used simply and inexpensively both in a level-regulating device containing an air-suspension valve and in an electronically controlled level-regulating device. This is achieved by the fact that a second electrically actuatable valve (6, 33, 45) is disposed in the housing (55).

The invention relates to a valve device according to the preamble of claim 1, for an air-suspension device for a vehicle.

A valve device of the class in question is known from German Patent 4202729 A1.

Air-suspension devices for vehicles are usually provided with a device for regulating the level of the vehicle body relative to the chassis or to the roadway. As regards such level-regulating devices, a distinction is made between two principles, one being a level-regulating device that operates purely mechanically by means of an air-suspension valve and the other an electronically controlled level-regulating device. A level-regulating device containing an air-suspension valve is known, for example, from the aforesaid prior art. An example of an electronically controlled level-regulating device can be found in European Patent 0779167 B1.

In level-regulating devices containing an air-suspension valve, a manually actuatable valve, which is often also referred to as a rotary slide valve, is usually provided in addition to the air-suspension valve. By means of the rotary slide valve, an operator can bypass the air-suspension valve and adjust the desired relative level of the vehicle body manually, by placing this rotary slide valve in the “Raise”, “Lower” or “Stop” positions. In this way there can be achieved a relative level needed, for example, for loading the vehicle at a loading dock. Such a rotary slide valve is additionally provided with a “Travel” position, in which the air-suspension valve becomes active once again. In the prior art cited in the foregoing, an electromagnetically actuatable valve is additionally provided for resetting the manual valve from the “Stop” position to the “Travel” position.

In electronically controlled level-regulating devices, control of the relative level takes place in any case via electromagnetically actuatable valves, both in the case of electronic regulation of the relative level and in the case of manual adjustment via an electrical operating unit.

Despite the persuasive advantages—such as considerably better regulation comfort and greater driving safety by virtue of refined regulation algorithms—offered by an electronically controlled level-regulating device compared with the embodiment containing an air-suspension valve, air-suspension valves are still being used in practice for cost reasons.

The object of the invention is therefore to provide, for an air-suspension device for a vehicle, a valve device that can be used simply and inexpensively both in a level-regulating device containing an air-suspension valve and in an electronically controlled level-regulating device.

This object is achieved by the invention specified in claim 1. Improvements and advantageous configurations of the inventions are specified in the dependent claims.

The invention has the advantage that it offers an inexpensive universal solution both for level-regulating devices containing an air-suspension valve and for electronically controlled level-regulating devices. The invention can be manufactured as a compact valve block, which either can be sold separately or can be sold as a compact electronic level-regulating unit combined with an electronic control device. As a result of the universal usability of the valve device, cost benefits compared with different valve devices for the different principles of the level-regulating devices are achieved in series production, since the inventive valve device can be manufactured in relatively high output volume by virtue of its universal usability.

A further advantage of the invention is that a vehicle equipped originally with an inventive valve device as well as with an air-suspension valve in order to satisfy cost reasons can be retrofitted with relatively little time and effort with an electronically controlled level-regulating device. For this purpose, the inventive valve device can be retained, while the air-suspension valve merely has to be replaced by what is known as a displacement sensor for sensing the relative level of the vehicle body. Furthermore, the valve device can be connected electrically to an electronic control device. Such a necessary electronic control device is usually already present in a vehicle, for example in the form of an electronics module, which is provided for an anti-brake-lock system and also has connections appropriate for the inventive valve device and the displacement sensor.

For application of the inventive valve device in an electronically controlled level-regulating device, a further advantage exists in that there are already provided manual operating elements for admitting air to and venting the air suspension bellows, or in other words for manually changing the relative level of the vehicle body. Hereby a manual change of relative level is possible even in the absence of power supply to the electronically controlled level-regulating device. A further advantage in this regard is that there is no need, especially for trailer vehicles, to provide an on-board battery or to supply a parked trailer vehicle externally with power by some other means, in order to be able to change the relative level manually, for example at a loading dock.

For application of the inventive valve device in a level-regulating device containing an air-suspension valve, a further advantage exists in that there is already provided an electrically actuatable valve, by means of which the regulating function of the air-suspension valve can be turned off, for example when the vehicle is stationary, in order to permit a manual change of the relative level, and by means of which the air-suspension valve can be reactivated when the vehicle starts to travel once again, in order to ensure a relative level that is safe for driving operation of the vehicle.

According to an advantageous improvement of the invention, a relay valve is provided. Relay valves can be manufactured relatively inexpensively, and they offer a large flow cross section for admission of air to and venting of the air-suspension bellows, thus permitting relatively rapid changes of relative level. According to an advantageous improvement of the invention, the relay valve is disposed in the housing of the valve device. Hereby there can be achieved a compact construction of the valve device. In addition, separate compressed-air lines to the relay valve do not have to be laid during installation of the valve device in the vehicle.

According to an advantageous improvement of the invention, a contactlessly operating displacement sensor for sensing the distance of the valve device from the roadway is provided in the housing. As an example, the displacement sensor can be configured as an ultrasonic sensor, as a radar sensor or as a sensor operating according to the light-reflection principle. Because the displacement sensor is disposed in the housing of the valve device, and because the valve device is mounted on the vehicle, usually on the vehicle frame, the said sensor is already mounted at a location suitable for transmitting a signal characteristic of the relative level of the vehicle body. Thus there is no need for separate mounting and cabling of the displacement sensor.

The invention will be explained in more detail hereinafter and further advantages will be pointed out on the basis of practical examples, using drawings, wherein

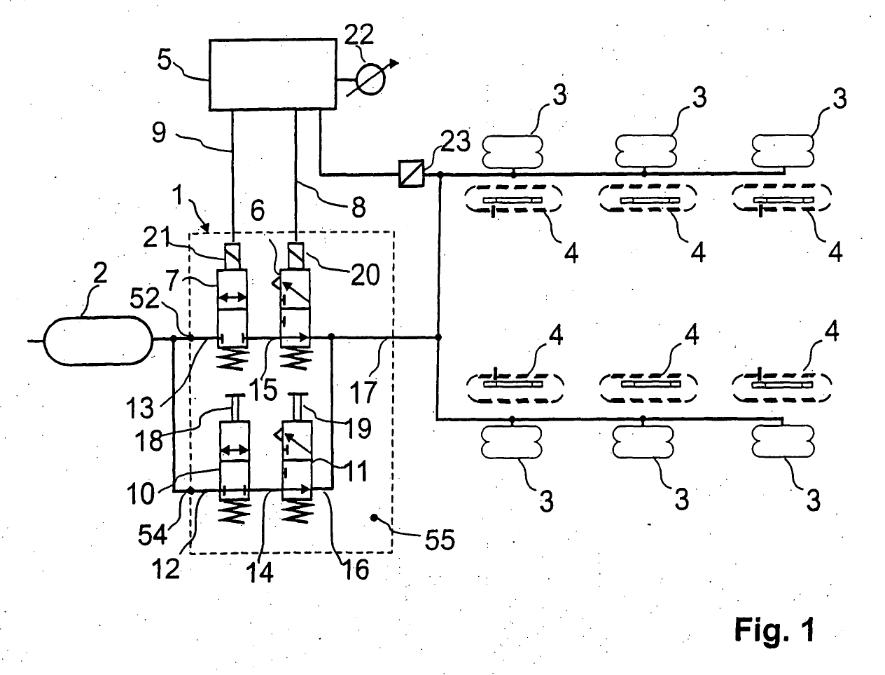

FIG. 1 shows a first embodiment of the inventive valve device for use in an electronically controlled level-regulating device, and

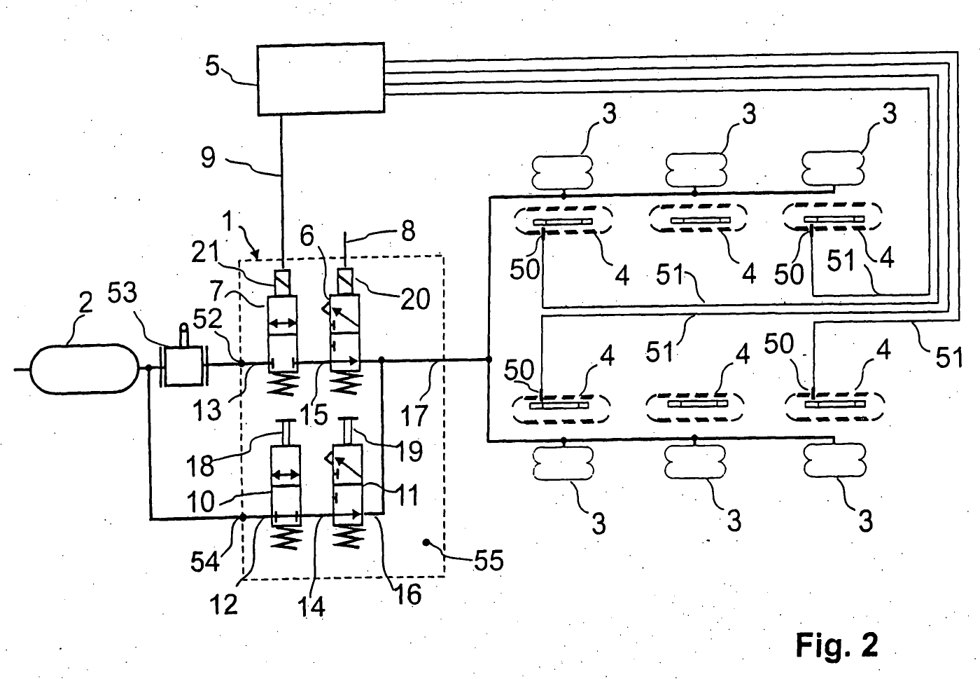

FIG. 2 shows the application of the aforesaid valve device in a level-regulating device containing an air-suspension valve, and

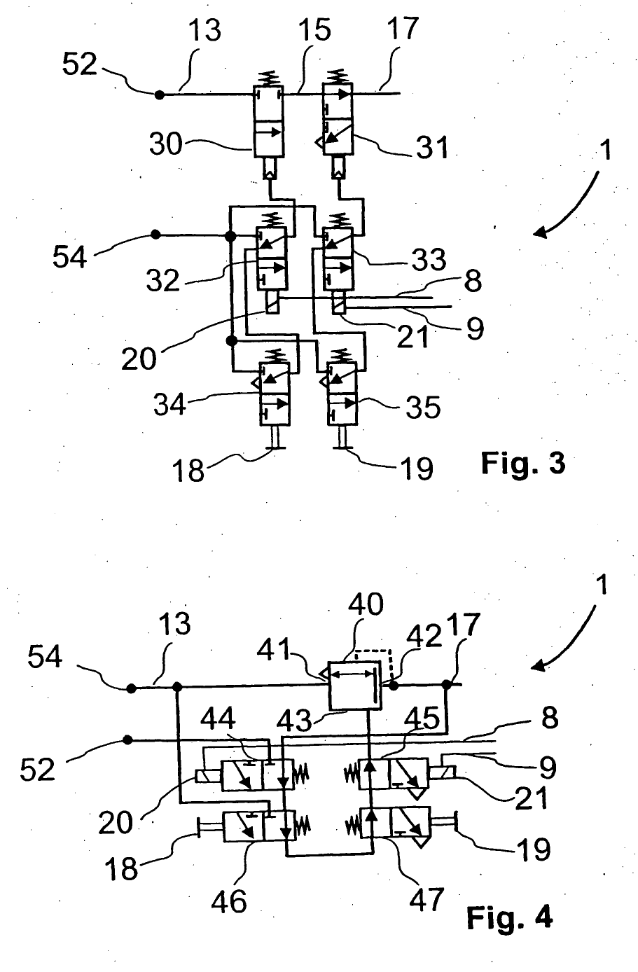

FIG. 3 shows a second embodiment of the inventive valve device, and

FIG. 4 shows a third embodiment of the inventive valve device.

In the figures, like reference numerals are used for parts corresponding to one another.

The air-suspension device for a vehicle illustrated in FIG. 1 is provided with air-suspension bellows (3), which are present in the vehicle in order to brace the vehicle body relative to wheels (4) or to the axles of the vehicle. The air-suspension device is also provided with an electronically controlled level-regulating device (1, 5, 22, 23), which for admission of air to air-suspension bellows (3) controls a compressed-air supply flow from a pressurized-fluid source (2) in communication with the level-regulating device to air-suspension bellows (3), and for venting of air-suspension bellows (3) controls a compressed-air discharge flow from air-suspension bellows (3) into the atmosphere.

Electronically controlled level-regulating device (1, 5, 22, 23) is provided with an electronic control device in the form of an electronic control unit (5), which can be supplied by an electrical energy source (not illustrated in FIG. 1). From a displacement sensor (22), which is used to measure the distance of the vehicle body from a reference point relative to wheels (4) and which in this way determines the relative level of the vehicle body, electronic control unit (5) receives a relative-level signal via an electrical line. Displacement sensor (22) can be configured, for example, as an ultrasonic sensor, as a radar sensor or as a sensor operating according to the light-reflection principle.

Furthermore, electronic control unit (5) receives a pressure signal from a pressure sensor (23), via an electrical line. Pressure sensor (23) is in communication on the pressure side with air-suspension bellows (3). Thus the transmitted pressure signal indicates the air pressure present in air-suspension bellows (3).

Electronic control unit (5) is connected via electrical lines (8, 9) to a valve device (1). Valve device (1) is provided with a housing (55), in which there are disposed a manually actuatable air-admission valve (10) for admission of air to the air-suspension bellows (3), a manually actuatable vent valve (11) for venting air-suspension bellows (3), a first valve (7) that can be electrically actuated via line (9) and a second valve (6) that can be electrically actuated via line (8). Electrically actuatable valves (6, 7) can be actuated by electronic control unit (5), by energizing electromagnets (20, 21) respectively via electrical lines (8, 9) respectively.

According to an advantageous improvement of the invention, housing (55) is provided with separate compressed-air ports (52, 54) for supplying compressed air from a pressurized-fluid source (2) to electrically actuatable valves (6, 7) on the one hand and to manually actuatable valves (10, 11) on the other hand. Hereby valve device (1) can be used particularly flexibly. For application of valve device (1) in an electronically controlled level-regulating device such as illustrated in FIG. 1, compressed-air ports (52, 54) are advantageously in communication with one another. For this purpose, first electrically actuatable valve (7) is in communication with pressurized-fluid source (2) via compressed-air port (52). Furthermore, manually actuatable air-admission valve (10) is in communication with pressurized-fluid source (2) via compressed-air port (54).

In one advantageous configuration of the invention, electronic control unit (5) as well as pressure sensor (3) are additionally disposed in housing (55). Hereby there is achieved a compact electronically controlled level-regulating device, which can be installed with little time and effort in a vehicle. According to a further advantageous configuration of the invention, displacement sensor (22) is additionally disposed in housing (55). Hereby there can be achieved a further reduction of the time and effort for installation of the level-regulating device in the vehicle.

Using predefined algorithms, electronic control unit (5) ascertains whether the measured relative level of the vehicle body would necessitate admission of air to or venting of air-suspension bellows (3) in order to maintain a desired index relative level. Thereupon, by actuating electrically actuatable valves (6, 7), it brings about admission of air to or venting of air-suspension bellows (3) as needed, in order to adapt the relative level measured by means of displacement sensor (22) to the index relative level.

Valve (6), which is designed as a 3/2 directional control valve, is used as a combined inlet/outlet valve, which assumes an inlet position in the de-energized state of electromagnet (20), as illustrated in FIG. 1, and an outlet position in the energized state of electromagnet (20). Valve (7), which is designed as a 2/2 directional control valve, is used as a holding valve, which assumes a shutoff position in the de-energized state of electromagnet (21), as illustrated in FIG. 1, and a passing position in the energized state of electromagnet (21). For admission of air to air-suspension bellows (3), electronic control unit (5) switches inlet/outlet valve (6) to inlet position and additionally switches holding valve (7) to passing position. Hereby pressurized-fluid source (2) is placed in communication with air-suspension bellows (3), so that compressed air can flow from pressurized-fluid source (2) via compressed-air lines (13, 15, 17) and valves (6, 7) into air-suspension bellows (3). For venting of air-suspension bellows (3), electronic control unit (5) switches inlet/outlet valve (6) to outlet-position and additionally switches holding valve (7) to shutoff position. Hereby pressurized-fluid source (2) is shut off and air-suspension bellows (3) are placed in communication with a vent port of inlet/outlet valve (6), so that compressed air can flow from air-suspension bellows (3) via compressed-air line (17) and valve (6) into the atmosphere. To hold the air pressure present in air-suspension bellows (3), electronic control unit (5) switches holding valve (7) to shutoff position and inlet/outlet valve (6) to inlet position.

In the air-suspension device illustrated in FIG. 1, all air-suspension bellows (3) are controlled together and always have the same pressure. It is also common practice to combine the air-suspension bellows into wheel groups or axle groups or even to control each air-suspension bellows individually. In such a case the electronically controlled level-regulating device must be augmented by appropriate valves for individual control of the air-suspension bellows or the groups of air-suspension bellows.

In addition to the already explained parts of the air-suspension device, there are provided, as manual actuating elements, two momentary-contact switches (18, 19), by manual actuation of which admission of air to and/or venting of air-suspension bellows (3) is possible even in the absence of power supply to electronically controlled level-regulating device (1) or to electronic control unit (5).

According to an advantageous configuration of the invention, valves (10, 11), which can be manually actuated via manual actuating elements (18, 19), are provided in a compressed-air branch (12, 14, 16) that is parallel to electrically actuatable valves (6, 7) and bypasses electrically actuatable valves (6, 7). Manually actuatable valves (10, 11) are advantageously designed as a pneumatic 2/2 directional control valve (10) and a pneumatic 3/2 directional control valve (11). Such directional control valves can be manufactured simply and inexpensively and are highly reliable in use.

According to an advantageous configuration of the invention, momentary-contact switches (18, 19) are connected mechanically to pneumatic directional control valves (10, 11). Via momentary-contact switches (18, 19), directional control valves (10, 11) respectively can be actuated against the force of a restoring spring. Directional control valve (10) then acts as an air-admission valve, which assumes a shutoff position in the non-actuated state of momentary-contact switch (18), as illustrated in FIG. 1, and an inlet position in the actuated state of momentary-contact switch (18). Directional control valve (11) then acts as a combined vent valve, which assumes a passing position in the non-actuated state of momentary-contact switch 19), as illustrated in FIG. 1, and a venting position in the actuated state of momentary-contact switch (19).

In the absence of power supply, a manual change of the relative level can be achieved by admitting air to or venting air-suspension bellows (3) as follows:

For air admission, momentary-contact switch (18) is manually actuated, meaning that directional control valve (10) is set to inlet position. Hereby compressed air can flow from pressurized-fluid source (2) via compressed-air lines (12, 14, 16) through directional control valve (10) as well as directional control valve (11), which is in passing position in the non-actuated state of momentary-contact switch (19), to air-suspension bellows (3). If it is desired to hold the air pressure or the relative level, momentary-contact switch (18) is merely released, whereby the flow of pressurized fluid is shut off. For venting, momentary-contact switch (19) is manually actuated, meaning that directional control valve (11) is set to venting position. Hereby compressed air can flow out of air-suspension bellows (3) via compressed-air line (16) and via a vent port of directional control valve (11) into the atmosphere. If it is desired to hold the air pressure or the relative level beginning from this state, momentary-contact switch (19) is merely released.

FIG. 2 shows the use of the valve device (1) explained in the foregoing in an air-suspension device containing an air-suspension valve (53). In this application of valve device (1), it is obvious that compressed-air ports (52, 54) are not in communication with one another. Compressed-air port (52) is connected to air-suspension valve (53), which in turn is connected to pressurized-fluid source (2). Compressed-air port (54) is directly connected to pressurized-fluid source (2). Hereby it is possible on the one hand to change the relative level manually by actuating momentary-contact switches (18, 19), as explained in the foregoing, while bypassing air-suspension valve (53).

Air-suspension valve (53) is in communication with the air-suspension bellows via electrically actuatable valves (6, 7). In this application of valve device (1), electrically actuatable valve (7) is connected, via electrical line (9), to an electronic control device (5), which in this case is designed as an electronics module already present in the vehicle for other purposes. As an example, electronics module (5) executes the functions of an anti-brake-lock system, and for this purpose is connected via electrical lines (51) to speed sensors (50) for measuring the speeds of revolution of wheels (4) as well as to brake-pressure regulating valves (not illustrated). In addition, electronics module (5) has connections appropriate for valve device (1) and displacement sensor (22). Electronics module (5) evaluates the signals of speed sensors (50) and extracts therefrom a signal indicating whether the vehicle is stationary or traveling. In the stationary mode, electronics module (5) switches electrically actuatable valve (7) to shutoff position, thus disabling air-suspension valve (53). If the vehicle is in travel mode, electronics module (5) switches electrically actuatable valve (7) to passing position, so that air-suspension valve (53) is placed in communication with air-suspension bellows (3) and can regulate the level of the vehicle body. Electrically actuatable valve (6) is not used in this application of valve device (1).

According to a further advantageous configuration of the invention, electrically actuatable valves (6, 7) are directly coupled mechanically with the manual actuating elements, which here again are designed as momentary-contact switches (18, 19), and in addition can be manually actuated via the manual actuating elements. Hereby there is achieved a further improvement in terms of compactness and manufacturing costs of valve device (1). In this case, valves (6, 7) can be actuated optionally by their momentary-contact switches (18, 19) respectively or by their electromagnets (20, 21) respectively, in each case against spring force.

In FIG. 3 there is illustrated a further configuration of the air-suspension device illustrated in FIG. 1 and FIG. 2, only the part of the air-suspension device concerning valve device (1) being shown as a detail in FIG. 3. The other parts of the air-suspension device correspond to FIG. 1 or FIG. 2.

According to FIG. 3 there are provided, as electrically actuatable valves, two 2/2 directional control valves (32, 33), which by analogy with the illustration of FIG. 1 can be actuated by electronic control unit (5) via electromagnets (20, 21) and electrical lines (8, 9). As manually actuatable valves there are provided two 2/2 directional control valves (34, 35), which can be manually actuated via the already mentioned momentary-contact switches (18, 19). Valves (32, 33, 34, 35) are in communication on the input side with compressed-air port (54), which in all cases of application of valve device (1) is to be placed in communication with compressed-air source (2).

According to an advantageous configuration of the invention, a servo-valve device (30, 31) is additionally provided in FIG. 3 for admission of air to and/or venting of air-suspension bellows (3). This servo-valve device (30, 31) can be actuated at least by electrically actuatable valves (32, 33) and by manual actuation—indirectly via compressed-air actuation by directional control valves (34, 35) in this case—of manual actuating elements (18, 19).

Servo-valve device (30, 31) is composed of a 2/2 directional control valve (30) that can be actuated by pressurized fluid and of a 3/2 directional control valve (31) that can also be actuated by pressurized fluid. Valve (30) acts as the holding valve and valve (31) acts as the combined inlet/outlet valve, the functions of valves (30, 31) corresponding respectively to the functions already explained with respect to valves (6, 7) of FIG. 1. In contrast to valves (6, 7), valves (30, 31) can be actuated by the pressurized fluid, via respective pressurized-fluid control inputs. Holding valve (30) is in communication via its pressurized-fluid control input with pressurized-fluid outputs of valves (32, 34). The pressurized-fluid control input of inlet/outlet valve (31) is in communication with pressurized-fluid outputs of valves (33, 35). Via compressed-air line (13), valve (30) is in communication with compressed-air port (52), which is to be placed in communication with compressed-air source (2) or with air-suspension valve (53), depending on the application.

Control of the relative level by appropriate action on electrically actuatable valve device (32, 33) takes place as already described with respect to FIG. 1. In the process, electrically actuatable valves (32, 33) act as pilot-control valves for valves (30, 31) respectively. For manual actuation, again as already described with respect to FIG. 1, momentary-contact switch (18) is to be manually actuated for admission of air to air-suspension bellows (3), while momentary-contact switch (19) is to be manually actuated for venting. In the process, valves (34, 35) also act as pilot-control valves for valves (30, 31) respectively. During admission of air to air-suspension bellows (3), compressed-air flows from compressed-air source (2) via compressed-air lines (13, 15, 17) to air-suspension bellows (3). During venting, compressed-air flows from air-suspension bellows (3) via compressed-air line (17) and a venting port of inlet/outlet valve (31) into the atmosphere.

In the case of application of valve device (1) containing an air-suspension valve (53), and when the vehicle is stationary, electronics module (5) switches valve (30) to shutoff position by non-actuation of electrically actuatable valve (32), so that air-suspension valve (53) is disabled. If the vehicle is in travel mode, electronics module (5) switches valve (30) to passing position by actuation of electrically actuatable valve (32), so that air-suspension valve (53) is placed in communication with air-suspension bellows (3) and can bring about regulation of the level of the vehicle body. Electrically actuatable valve (33) is not used in this application of valve device (1).

In FIG. 4 there is illustrated a further advantageous configuration of the inventive air-suspension device, only the part of the air-suspension device concerning the valve devices being shown, as in the case of FIG. 3. The other parts of the air-suspension device correspond to FIG. 1 or FIG. 2.

In the configuration according to FIG. 4 there is provided, as the servo-valve device, a relay-valve device (40), which has the characteristic that it outputs the pressure present at a pressure-control input (43) to a compressed-air output (42), while maintaining the same pressure head. For the purpose of venting compressed air from air-suspension bellows (3) into the atmosphere, relay-valve device (40) is provided with a vent port. To supply compressed air to air-suspension bellows (3), relay-valve device (40) is in communication, by means of a pressurized-fluid input port (41) and via compressed-air line (13), with compressed-air port (54), which in all cases of application of valve device (1) is to be placed in communication with compressed-air source (2).

As shown in FIG. 4, the electrically actuatable valves are configured as a combined air-admission/holding valve (44), which is designed as a 3/2 directional control valve, and also as a vent valve (45), which is designed as a 2/2 directional control valve, which valves can be actuated by electronic control unit (5), via electromagnets (20, 21) respectively. By analogy with the aforesaid electrically actuatable valve device, the manually actuatable valve device is also provided with a combined air-admission/holding valve (46), which is designed as a 3/2 directional control valve, as well as with a vent valve (47), which is designed as a 2/2 directional control valve, which valves can be manually actuated by momentary-contact switches (18, 19) respectively. By means of a pressurized-fluid input port, electrically actuatable air-admission/holding valve (44) is in communication with compressed-air port (52). By means of a pressurized-fluid input port, manually actuatable air-admission/holding valve (46) is in communication via compressed-air line (13) with compressed-air port (54). Via vent valve (45), vent valve (47), air-admission/holding valve (46) and air-admission/holding valve (44), pressure-control input (43) of relay-valve device (40) is looped back to compressed-air output (42) of relay-valve device (40). If electrically actuatable valves (44, 45) and manually actuatable valves (46, 47) are not actuated, as illustrated in FIG. 4, pressure-control input (43) and compressed-air output (42) of relay-valve device (40) are in communication with one another. As a result, relay device (40) exerts a pressure-holding function, to the effect that the pressure present in compressed-air line (17) is held constant.

In the case of application of electronically controlled level regulation, and air is to be admitted to air-suspension bellows (3), electronic control unit (5) exercises the level-regulating functions by acting via electrical line (8) on electromagnet (20) to actuate valve (44). Hereby compressed air is delivered from pressurized-fluid source (2) to pressure-control input (43). Relay-valve device (40) attempts to adjust the pressure at compressed-air output (42) to that present at pressure-control input (43), by the fact that relay-valve device (40) passes compressed air from pressurized-fluid input port (41) through to compressed-air output (42). If air-suspension bellows (3) are to be vented, electronic control unit (5) actuates electromagnet (21) via electrical line (9) in order to actuate valve (45). Hereby pressure-control input (43) of relay-valve device (40) is placed in communication with the vent port of vent valve (45) and therefore with the atmosphere. Relay-valve device (40) attempts to adjust the pressure at compressed-air output (42) to that present at pressure-control input (43), by the fact that relay-valve device (40) allows compressed air to flow out of air-suspension bellows (3) via the vent port of relay-valve device (40) into the atmosphere.

For a manual change of relative level, momentary-contact switch (18) is to be actuated for admission of air to air-suspension bellows (3) and momentary-contact switch (19) is to be actuated for venting of air-suspension bellows (3). In the process, the actuation of momentary-contact switch (18) brings about a reversal of air-admission/holding valve (46) to the effect that pressure-control input (43) of relay-valve device (40) is placed in communication with pressurized-fluid source (2). In turn, relay-valve device (40) attempts to adjust the pressure at compressed-air output (42) to the pressure present at pressure-control input (43), by the fact that relay-valve device (40) passes compressed air from pressurized-fluid input port (41) through to compressed-air output (42). Actuation of momentary-contact switch (19) brings about a reversal of vent valve (47) to the effect that pressure-control input (43) of relay-valve device (40) is placed in communication with the vent port of vent valve (47). In turn, relay-valve device (40) attempts to adjust the pressure at compressed-air output (42) to the pressure present at pressure-control input (43), by the fact that relay-valve device (40) allows compressed air to flow out of air-suspension bellows (3) via the vent port of relay-valve device (40) into the atmosphere.

In the case of application of the mechanically operating level control device containing an air-suspension valve, air-suspension valve (53) is again connected to compressed-air port (52) in the embodiment according to FIG. 4. In this case, air-suspension valve (53) brings about level regulation by changing the pressure at pressure-control input (43) while valve (44) is switched to passing position.

According to an advantageous configuration of the invention, servo-valve device (30, 31, 40) is mechanically coupled with manual actuating element (18, 19) and can be manually actuated via manual actuating element (18, 19). In the case of the configuration of the servo-valve device according to FIG. 3, the manual actuating elements can be mechanically coupled with valves (30, 31) respectively, meaning that momentary-contact switch (18) is mechanically coupled with valve (30) and momentary-contact switch (19) with valve (31). In the case of the configuration of the servo-valve device according to FIG. 4, the manual actuating elements can be directly coupled mechanically with relay-valve device (40). This means, for example, that they can act mechanically from opposite sides on a relay piston provided in relay-valve device (40).

According to an advantageous improvement of the invention, electronically controlled level-regulating device (1) is suitable for receiving at least one input variable, to be predefined manually, in which case the input variable can be predefined via manual actuating element (18, 19) even in the presence of power supply to electronically controlled level-regulating device (1). Such an input variable is preferably a manually predefined relative level or change of relative level compared with the previously adjusted relative level. This has the advantage that these same actuating elements can be used at any time to predefine the input variable, regardless of whether or not the level-regulating device is being supplied with electrical power. Additional actuating elements such as electric momentary-contact switches are not necessary. Furthermore, a simple kind of operator control is achieved hereby, since an operator does not have to make sure of actuating different operating elements according to the state of the power supply.

According to an advantageous improvement of the invention, electronically controlled level-regulating device (1) is suitable for receiving at least one distance signal from a displacement sensor (22) as well as one pressure signal from a pressure sensor (23). Level-regulating device (1) or electronic control unit (5) evaluates the distance signal and the pressure signal continuously, and on the basis of the variation of these signals detects whether an input variable such as a change of relative level has been predefined manually. In the process, electronic control unit (5) advantageously checks whether the distance signal is changing while the pressure signal remains substantially constant. This is an indication of a manually predefined change of relative level, to the effect that a certain quantity of air has been discharged from or injected into air-suspension bellows (3) at substantially constant vehicle weight. Since it can be assumed during such a manual change of relative level that the vehicle cargo and therefore the vehicle weight remained constant, the pressure in air-suspension bellows (3) does not change as a result, but instead only the volume of compressed air stored therein is changed by a change in relative level. However, if the electronic control unit detects that the pressure signal and the distance signal are changing, this is an indication that the vehicle cargo has been changed. In this case electronic control unit (5) does not infer a manually predefined input variable.

The valve devices according to FIG. 3 and FIG. 4 are applicable both in a mechanically operating level-regulating device containing an air-suspension valve and in an electronically controlled level-regulating device.

According to an advantageous configuration of the invention, a rotary arm known from conventional rotary slide valves can also be used instead of two separate momentary-contact switches (18, 19). This rotary arm brings about admission of air to air-suspension bellows (3) in one end position and venting of air-suspension bellows (3) in another end position.

1. A valve device (1) for an air-suspension device for a vehicle, containing a manually actuatable air-admission valve (10, 34, 46) for admission of air to the air-suspension bellows (3) of the air-suspension device, a manually actuatable vent valve (11, 35, 47) for venting the air-suspension bellows (3) and a first electrically actuatable valve (7, 32, 44), the air-admission valve (10, 34, 46), the vent valve (11, 35, 47) and the first electrically actuatable valve (7, 32, 44) being disposed in a common housing (55), characterized in that a second electrically actuatable valve (6, 33, 45) is disposed in the housing (55).

2. A valve device according to claim 1, characterized in that the housing (55) is provided with separate compressed-air ports (52, 54) for supplying compressed air from a pressurized-fluid source (2) to the electrically actuatable valves (6, 7, 32, 44) on the one hand and to the manually actuatable valves (10, 11, 34, 35, 46, 47) on the other hand.

3. A valve device according to claim 1 or 3, characterized in that there is provided a relay valve (40).

4. A valve device according to claim 3, characterized in that the relay valve (40) is disposed in the housing (55).

5. A valve device according to at least one of claims 3 or 4, characterized in that the relay valve (40) is provided with a compressed-air inlet (41), a compressed-air outlet (42) and a control port (43) that can be actuated by compressed air, wherein the compressed-air outlet (42) can be placed in communication with the control port (43) via a compressed-air connecting line.

6. A valve device according to claim 5, characterized in that at least one valve among the air-admission valve (46), vent valve (47), first electrically actuatable valve (44) or second electrically actuatable valve (45) is disposed in the compressed-air connecting line from the compressed-air outlet (42) to the control port (43).

7. A valve device according to claim 5, characterized in that at least the air-admission valve (46), the vent valve (47), the first electrically actuatable valve (44) and the second electrically actuatable valve (45) are disposed in the compressed-air connecting line from the compressed-air outlet (42) to the control port (43).

8. A valve device according to at least one of the preceding claims, characterized in that a contactlessly operating displacement sensor (22) for sensing the distance of the valve device (1) from the roadway is provided in the housing (55).

9. The use of a valve device according to at least one of the preceding claims in an air-suspension device containing an air-suspension valve (53), wherein the compressed-air inlet of the first electrically actuatable valve (7, 32, 44) is in communication with the air-suspension valve (53) via the compressed-air port (52) of the housing (55).

10. The use of a valve device according to at least one of claims 1 to 8 in an air-suspension device with electronically controlled level regulation and an electronic control device (5), wherein the first and the second electrically actuatable valves (6, 7, 32, 33, 44, 45) can be actuated by the electronic control device (5) for admission of air to and venting of the air-suspension bellows (3).

11. The use of a valve device according to claim 10, characterized in that the compressed-air inlet of the first electrically actuatable valve (7, 32, 44) is in communication with a pressurized-fluid source (2) via the compressed-air port (52) of the housing (55).
